(19) United States
(12) Patent Application Publication
(10) Pub. No.: US 2003/0077947 A1
(43) Pub. Date: Apr. 24, 2003

(54) High voltage connector

(75) Inventor: Kenji Sugimori, Toyama-Ken (JP)

Correspondence Address: Thomas R. Morrison, Esq., MORRISON LAW FIRM, 145 North Fifth Avenue, Mount Vernon, NY, 10550, US

(73) Assignee: SMK CORPORATION

(21) Appl. No.: 10/172,446

(22) Filed: Jun. 14, 2002

(30) Foreign Application Priority Data
Oct. 18, 2001 (JP) 2001-320042

(51) Int. Cl. H01R 13/502

(52) U.S. Cl. 439/686

(57) ABSTRACT

A connector structure for a light source lamp includes plug connection side recesses in a connector housing for receiving plug pins. Cable connection terminals at a rear side of the plug pins are directed approximately orthogonal to a plug connecting direction. Shield walls for the cable connection terminals in the connector housing lengthen the creepage path between the plug pins and the cable connection terminals. In one embodiment, electrical cover members, covering the cable connection terminals, are used in conjunction with, or in the alternative to the shield walls to lengthen the creepage path.

### BACKGROUND OF THE INVENTION

1. Field of the Invention

The present invention relates to a high voltage connector plug used for connecting a light source lamp in a liquid crystal projector and the like with a power supply.

2. Description of the Related Art

A light source in an electronic device, such as a liquid crystal projector, generally employs a replaceable lamp.

There are following reasons. Lamp life is about 1,000 hours, which is relatively short. This makes it necessary to replace the lamp.

Also, a high voltage of 20 to 30 kV is impressed to generate a high luminance of the light source. Such high voltages require that the elements of the lamp be able to withstand high voltage in order to prevent a creepage distance leak or a clearance leak.

Lamp surface temperatures increase to about 300° C. when the lamp is emitting light. Thus, high heat resistance property is required in surrounding parts. It is easier to unitize the light source for satisfying these requirements, and for assembling an electronic device.

FIG. 4 shows an example of a prior-art lamp unit 1 in which a light source is unitized.

A lamp 3 is installed in a lamp housing 2 in the lamp unit 1. A bolt and a nut are used to install a harness attaching terminal to a rear part of the lamp, and connector plugs 110 are attached to the terminal through cables 50.

FIG. 3 shows an example of a method for connecting the cables and the connector plugs 110 with each other. Plug pin storage recesses are provided in a connector housing 111. Straight plug pins 130 are provided in the plug pin storage recesses. A cable connection terminal 131 is provided at a rear part of the plug pin. A cable 50 is connected to the cable connection terminal 131. This results in a connector having an almost straight shape.

Because high withstanding voltage property and high heat resistance property are required for the cable, a cable core 51 is coated with silicone or fluororesin. In addition, a protective tube, such as a fluororubber tube or a glass woven tube, is provided thereover.

The housing is formed of a heat resistant resin such as PPS. Electric shield walls are provided for the cable connection terminal as well as for the plug pin for securing high withstanding voltage capability in the connector.

When a light source unit is structured such that a lamp and connector plugs are connected with a cable as shown in FIG. 4, and a power supply side connector socket is connected in an approximately orthogonal direction to a wiring direction of the lamp and the cables, a total length of the cables between the lamp and the connector can be quite short. However, space is required for bending the cable at the connector plug connection as shown in FIG. 3. Also, because high withstanding voltage property and high heat resistance property are required for the cables, and the cables are covered with silicone or fluororesin, and the protective tube is installed, it is best that the cables are not bent over a steep angle. Otherwise, cracks may develop. This is one reason that the prior-art light source unit resists reduction in size.

### OBJECTS AND SUMMARY OF THE INVENTION

In view of the foregoing, an object of the present invention is to provide a connector structure capable of reducing installation space for a high voltage connector for a light source lamp.

It is a further object of the invention to provide a high voltage connector which includes means for lengthening a creepage path between terminals of the light source lamp.

It is a further object of the invention to provide a high voltage connector which includes means for lengthening a creepage path between cable connection terminals.

A high voltage connector according to a first aspect of the invention comprises a connector housing having plug connection side recesses formed for storing plug pins, the plug pins being provided in the plug connection side recesses, cable connection terminals provided at respective rear sides of the plug pins in a direction approximately orthogonal to a plug connecting direction, and shield walls for cable connection terminals provided in the connector housing.

Because the cable connection terminal at the rear side of the plug pin is provided approximately orthogonal to the direction for connecting the plug with a power supply side connector socket, the connector is installed without bending the cable as shown in FIG. 1, and the installation space is reduced accordingly.

The shield walls for the cable connection terminals are provided in the connector housing. This is because in a case where the two plug pins are provided in parallel with each other in the connector for a light source lamp for connecting a positive electrode and a negative electrode as shown in FIG. 1, a high voltage of 20 kV to 30 kV is impressed between the electrodes, and a generation of a creepage distance leak and a clearance leak between the cable connection terminals should be prevented. For this purpose, shield walls are provided between the cable connection terminals for securing long creepage distances.

A high voltage connector according to a second aspect of the invention comprises a connector housing having plug connection side recesses formed for storing plug pins, the plug pins being provided in the plug connection side recesses, cable connection terminals provided at respective rear sides of the plug pins in a direction approximately orthogonal to a plug connecting direction, and cover members for covering cable connection terminals.

A purpose of the second aspect is to reduce the height of the insulating walls for the cable connection terminals according to the first aspect, and to provide an efficient structure for further reducing the installation space of the connector. For example, as shown in FIG. 2, the cover members are attached for covering the cable connection terminals of the individual terminals, and for increasing the creepage distances along the shield walls.

The above, and other objects, features and advantages of the present invention will become apparent from the following description read in conjunction with the accompanying drawings, in which like reference numerals designate the same elements.

### BRIEF DESCRIPTION OF THE DRAWINGS

FIGS. 1A and 1B show front and side views, respectively, of a connector according to the first aspect of the invention.

FIGS. 2A and 2B show front and side views, respectively, of a connector according to the second aspect of the invention.

FIG. 3 shows an example of a conventional straight connector.

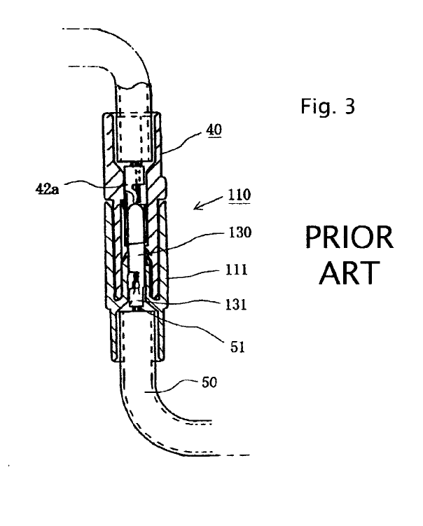

FIG. 4 shows an example of a conventional light source unit.

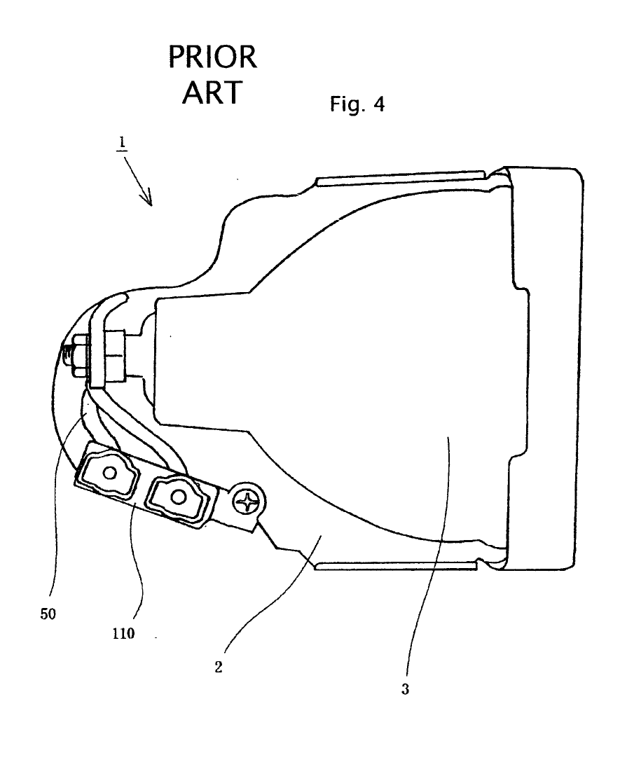

### DETAILED DESCRIPTION OF THE PREFERRED EMBODIMENTS

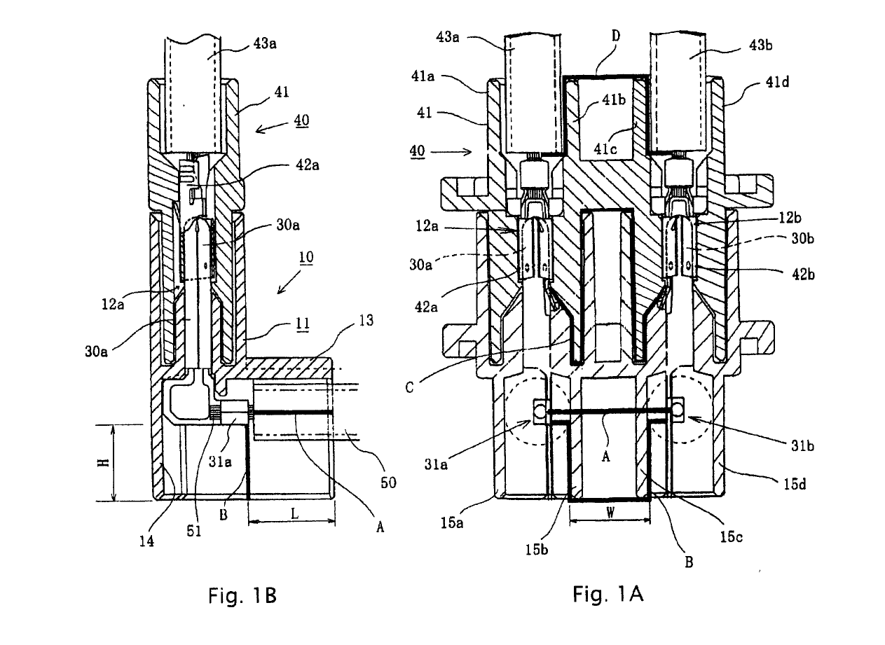

Referring to FIGS. 1A and 1B, a connector 10 includes a connector housing 11 having plug connection side recesses 12a and 12b. Connector housing 11 is preferably made of heat resistant resin such as PPS. Plug pins 30a and 30b are provided in the plug connection side recesses 12a and 12b. Cable connection terminals 31a and 31b are provided at the rear side of the plug pins 30a and 30b in a direction almost orthogonal to the plug pins. Cable cores 51 of cables 50 are soldered to the cable connection terminals 31a and 31b.

A top shield wall 13, a rear shield wall 14, and side shield walls 15a, 15b, 15c, and 15d are provided around the cable connection terminals 31a and 31b.

Creepage distances between the cable connection terminals 31a and 31b are A, B, and C shown in FIGS. 1A and 1B.

The creepage distance A is a sum of the following creepage distances:

1) from an exposed root of the cable core of the cable 50 for connecting with the cable connection terminal 31a shown in FIG. 1A

2) to an opening end of the side shield wall 15b in the cable connection direction (along a protective cover tube for the cable 50) on the side shield wall 15b shown in FIG. 1B (a depth L)

3) a clearance W from the opening end of the side shield wall 15b to an opening end of the side shield wall 15c of the counter electrode, and

4) a creepage distance of the depth of the counter electrode (the cable connection terminal 31b) from the opening end of the side shield wall 15c.

The creepage distance B is a sum of the following:

1) a height H of the side shield wall 15b from the cable connection terminal 31a in the vertical direction in FIGS. 1A and 1B,

2) the clearance W between a bottom end of the side shield wall 15b and a bottom end of the side shield wall 15c of the counter electrode, and

3) the height H of the counter electrode as shown in FIGS. 1A and 1B.

Thus, because the clearance W is the same, the depth L and the height H of the side shield walls determine the difference between the creepage distances A and B.

The height of the side shield walls 15b and 15c is set such that the creepage distance B is equal to or more than the creepage distance A.

The creepage distance C is a creepage distance between the plug pins along the socket, engaging the connector socket 40 connected with the power supply provides a relatively long distance along the engagement surface.

Contact sockets 40 include a socket housing 41 having socket terminals 42a and 42b. Socket cables 43a and 43b are connected to a rear part of the socket terminals 42a and 42b. The socket housing includes socket terminal shield walls 41a, 41b, 41c, and 41d. A creepage distance D is determined by the sum of the heights of the shield walls 41b and 41c, and a clearance at their top end.

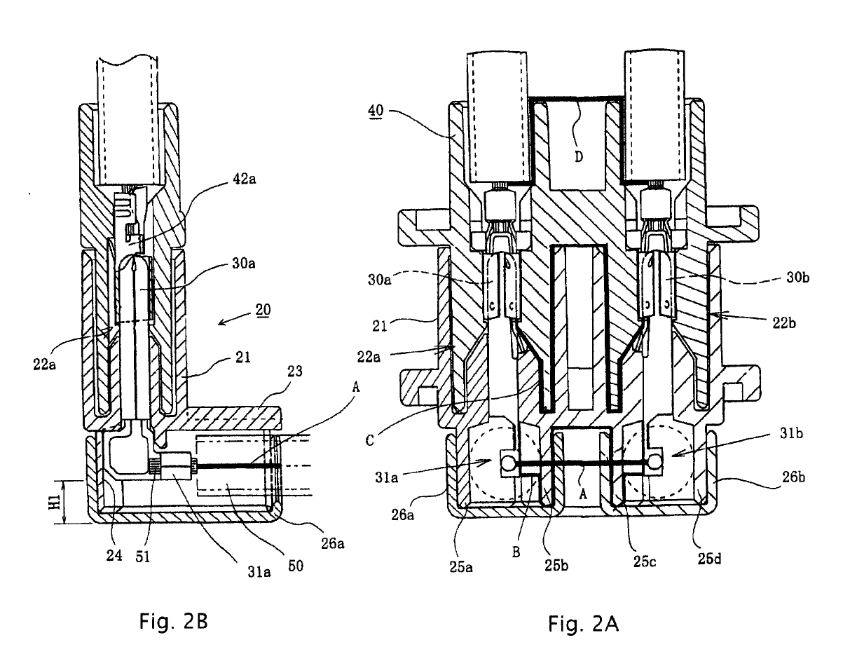

Referring now to FIGS. 2A and 2B, an embodiment according to the second aspect of the invention includes a connector 20 includes a connector housing 21 having plug connection side recesses 22a and 22b, which house plug pins 30a and 30b. Cable connection terminals 31a and 31b are provided at the rear side of the plug pins 30a and 30b in a direction almost orthogonal to the plug pins. Cable cores 51 of the cables 50 are soldered to the cable connection terminals 31a and 31b as in the connector 10 in the previous embodiment.

The connector 20 is different from the connector 10 on the following points. In the embodiment of FIGS. 1A and 1B, the creepage distance B in connector 10 is increased by increasing the height H of the side shield walls 15b and 15c. Also, in this embodiment, vertical space is necessary for providing the shield walls 15b and 15c. In contrast, the connector 20 of FIGS. 2A and 2B includes a top shield wall 23, a rear shield wall 24, and side shield walls 25a, 25b, 25c, and 25d. Although a height H1 of the rear shield wall 24, and of the side shield walls 25a, 25b, 25c, and 25d are lower than is the case for corresponding elements in the embodiment of FIGS. 1A and 1B, cover members 26a, and 26b are attached as electrical shields in the connector 20. This lengthens the creepage distance along the engagement surfaces of the side shield walls and the cover members. In addition, the vertical space is desirably decreased.

These cover members 26a and 26b are of the press-on engaging type. This permits installing the cover members 26a and 26b after the remaining parts, such as plug pins, are assembled. Individual cover members 26a and 26b may be provided for the individual terminals or the two cover members may be formed as a single unit.

While these embodiments are described as structures for the connector plugs, they can be applied to connector sockets, without departing from the spirit and scope of the invention.

Because the cable connection terminal at the rear side of the plug pin is provided approximately orthogonal to the direction of the plug pin for connecting with the power supply side connector socket in the present invention, the cables connected the connector plugs can be installed without bending, the space for the installation is reduced, and the size of the light source unit can be reduced accordingly.

The shield walls or the cover members are provided around the cable connection terminals of the plug, the creepage distances between the plugs are long enough, and excellent high withstanding voltage is provided.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A high voltage connector comprising:
a connector housing;
first and second plug connection side recesses in said connector housing;
first and second plug pins in said first and second plug connection side recesses, respectively;
cable connection terminals at respective rear sides of said first and second plug pins;
said cable connection terminals being directed approximately orthogonal to a plug connecting direction;
shield walls between cable connection terminals in said connector housing; and
said shield walls being positioned to lengthen a creepage path between said cable connection terminals.

2. A high voltage connector, comprising
a connector housing;
first and second plug connection side recesses in said connector housing;
first and second plug pins in said first and second plug connection side recesses;
first and second cable connection terminals at respective rear sides of said first and second plug connection side recesses, respectively;
said first and second cable connection terminals being directed approximately orthogonal to a connection direction of said first and second plug pins;
at least one cover member for covering said first and second cable connection terminals; and
said at least one cover member being effective for lengthening a creepage path between said first and second cable connection terminals.

3. A high voltage connector comprising:
a housing;
first and second plug connection recesses in said connector housing;
first and second plug pins in said first and second plug connection recesses;
a contact socket;
said contact socket interfitting with said housing to lengthen a creepage distance between said first and second plug pins.

4. A high voltage connector according to claim 3, further comprising:
first and second cable connection terminals at respective rear sides of said first and second first and second plug connection side recesses;
means for lengthening a creepage distance between said first and second cable connection terminals; and
said first and second cable connection terminals being directed substantially orthogonal to a connection direction of said first and second plug pins.
